(19) United States
(12) Patent Application Publication
(10) Pub. No.: US 2022/0276503 A1
(43) Pub. Date: Sep. 1, 2022

(54) EYEGLASSES WITH SEPARABLE FRAME MEMBERS

(71) Applicant: Invicta Watch Company of America, Inc., Hollywood, FL (US)

(72) Inventor: Eyal Lalo, Hallandale, FL (US)

(21) Appl. No.: 17/187,557

(22) Filed: Feb. 26, 2021

(51) Int. Cl. G02C 5/02; G02C 3/00

(52) U.S. Cl. CPC G02C 5/02; G02C 3/006; G02C 2200/02

(57) ABSTRACT

An eyeglass frame having a pair of magnetically connected lens holding members are releasably connected at a bridge portion of each lens holding member. The bridge portions butt face to face against one another along a first common vertical plane when connected. Extending transversely from one bridge portion and through the common plane is a bolt having an irregular cross section. The bolt includes a magnet affixed to its end. The bolt is received in a socket formed in the other bridge portion. A mating magnet is affixed to the internal end of the socket. Butting faces of the magnets at a second common plane secure the lens holding members in position

### BACKGROUND OF THE INVENTION

### 1. Field of the Invention

The present invention relates generally to eyeglasses and more specifically to eyeglass frames which are magnetically separable at a bridge interconnecting two lens holding frame members.

### 2. Antecedents of the Invention

Eyeglasses with frames comprising two separable lens holding members interconnected at a bridge have been heretofore suggested. Many, such as those disclosed in U.S. Pat. No. 5,110,198 issued to Travis, U.S. Pat. No. 4,610,519, issued to Hyman and U.S. Pat. No. 4,756,612 issued to Hyman, comprised novelty items, not intended for use with corrective lenses did not attain commercial acceptance in the novelty field or otherwise.

The implementation of magnetic components in conjunction with eyeglasses to releasably join separable symmetric lens holding members has been disclosed in U.S. Pat. No. 6,253,388 issued to Lando, U.S. Pat. No. 7,931,366, issued to Lando and U.S. Pat. No. 8,025,396, issued to Power. The lens holding members include bridge portions having a common vertical plane. The magnetic components within each bridge portion had engagement faces which were coplanar with the common vertical plane.

The lens holding members were joined at the common vertical plane and were separable by merely pulling apart (tension force), as illustrated in U.S. Pat. No. 7,931,366 (FIG. 4A), and U.S. Pat. No. 6,253,388, or by a torquing force, as illustrated in U.S. Pat. No. 8,025,396.

Due to the nature of the forces applied for separation, these eyeglasses designs were prone to Inadvertent separation of the lens holding members, resulting in temporary loss of or decrease in visual perception and possible loss of the eyeglasses, if for example, the eyeglasses were being worn during a sporting event or during swimming.

### SUMMARY OF THE INVENTION

Eyeglasses having magnetically connected symmetric lens holding members are releasably coupled at a bridge portion of each lens holding member. The coupled bridge portions butt face to face against one another along a common vertical plane. Extending transversely from one bridge portion and through the common plane is a bolt having an irregular cross section which is received in a mating socket formed in the other bridge portion. The bolt comprises a magnet or includes a magnet affixed to its end. A mating magnet is affixed to the internal end of the socket.

The lens holding members are thus precluded from rotating relative to one another and are not subject to accidental separation.

From the foregoing compendium, it will be appreciated that an aspect of the present invention is to provide eyeglasses with separable frame members of the general character described which are not subject to the aforementioned disadvantages of the antecedents of the invention.

A feature of the present invention is to provide eyeglasses with separable frame members of the general character described which are readily adaptable for use during activities such as sporting events.

A consideration of the present invention is to provide eyeglasses with separable frame members of the general character described which are easy to use.

Another feature of the present invention is to provide eyeglasses with separable frame members of the general character described which resists separation of the frame members due to torsional forces.

A further aspect of the present invention is to provide eyeglasses with separable frame members of the general character described which are well suited for mass production fabrication.

Another feature of the present invention is to provide eyeglasses of the general character described with magnetically and structurally interlocked frame members.

A further consideration of the present invention is to provide eyeglasses of the general character described with separable frame members coupled through an irregular bolt extending from one frame member into an irregular socket formed in the other frame member.

To provide eyeglasses with magnetically coupled separable frame members of the general character described which are relatively low in cost is another feature of the present invention.

A still further aspect of the present invention is to provide eyeglasses with separable frame members of the general character described wherein the frame members self-align when coupled together.

Other aspects, features and considerations of the present invention in part will be obvious and in part will be pointed out hereinafter.

With these ends in view, the invention finds embodiment in various combinations of elements, arrangements of parts and series of steps by which the above-mentioned aspects, features and considerations and certain other aspects, features and considerations are attained, or with reference to the accompanying drawings and the scope of which will be more particularly pointed out and indicated in the appended claims.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is perspective view of a pair of eyeglasses having separable lens holding frame members in accordance with the invention;

FIG. 2 is a perspective view of a lens holding frame member having a bridge portion and carrying a right lens and with an irregular bolt projecting laterally from a planar face of the bridge portion, the same being taken substantially along the plane 2-2 of FIG. 1;

FIG. 3 is a perspective view of a lens holding frame member having a bridge portion and carrying a left lens and with a irregular socket extending internally from a planar face of the bridge portion, the same being taken substantially along the plane 3-3 of FIG. 1

FIG. 4 is an enlarged scale fragmentary sectional view through the bridge portion depicted in FIG. 2, the same being taken along the plane 4-4 of FIG. 2 and better illustrating a magnet affixed to the end of the irregular bolt:

FIG. 4A is an enlarged scale fragmentary sectional view through the bridge portion depicted in FIG. 2, similar to FIG. 4, however, wherein the entire bolt is formed of a magnetic material; and

FIG. 5 is an enlarged scale fragmentary sectional view through the bridge portion depicted in FIG. 3, the same being taken along the plane 5-5 of FIG. 3 and better illustrating the irregular cross section of the socket formed within the planar face of the bridge portion as well as a magnet seated at the internal end of the socket.

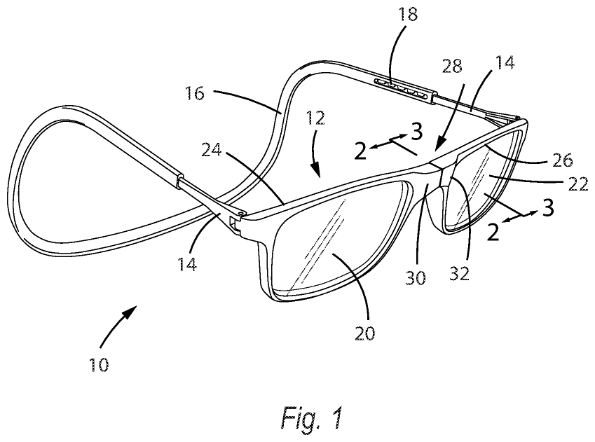

### DETAILED DESCRIPTION

The present invention will now be described in detail with reference to the illustrations which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

Moreover, where certain elements of the present invention can be partially or fully implemented using known components, only those portions of such known components that are necessary for an understanding of the present invention will be described, and detailed descriptions of other portions of such known components will be omitted so as not to obscure the invention.

Referring now in detail to the drawings, the reference nominal 10 denotes generally a pair of eyeglasses constructed in accordance with and embodying the invention. The eyeglasses comprise a frame 12, a pair of temples 14 hinged to opposite ends of the frame 12 and a neck band or strap 16 which interconnects the ends of the temples 14. An adjustment mechanism 18 may be provided to vary the effective length of the strap 16, all as disclosed in one or more of the following US Patents, which are incorporated herein by reference in their entireties: U.S. Pat. Nos. 7,931,366, 8,025,396, 9,687,358 and U.S. Pat. No. D758,475.

Pursuant to the invention, a right lens 20 and a left lens 22 are mounted in the frame 12 which is comprised of a first lens holding frame member 24 and second lens holding frame member 26, respectively. The lens holding frame members 24, 26 are releasably interconnected at a bridge 28 comprised of two portions. A first bridge portion 30 is integral with the first lens holding frame member 24 and a second bridge portion 32 is integral with the second lens holding frame member 26.

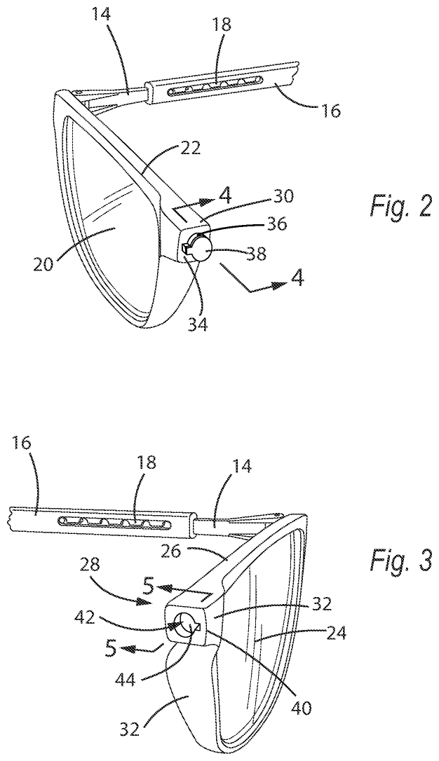

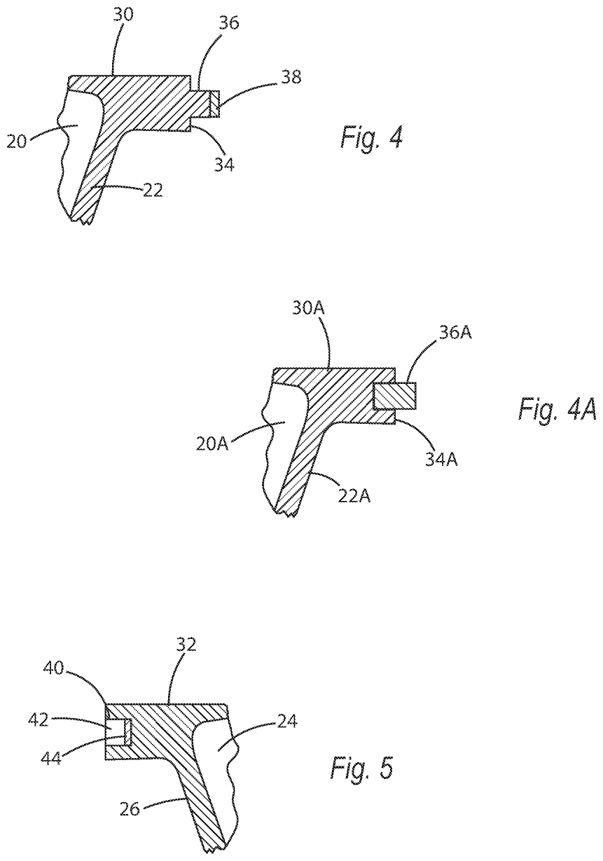

With reference now to FIGS. 2 and 4, it will be noted that the first bridge portion 30 includes a planar face 34. A bolt 36 having an irregular cross section, e.g. a chordal arc 37 having a radially projecting axial spline 39 and may be formed as a single unit with the first bridge portion 30. A magnet 38 is secured to the distal end of the bolt 36.

As will be noted from an examination of FIG. 3 and FIG. 5, the second bridge portion 32 includes a planar face 40. A socket 42 extends from the planar face 40 transversely into the second bridge portion 32. The socket 42 includes a mating irregular cross section, e.g. a chordal arc with a keyway 43 for receiving the spline 39. Secured at the internal end of the socket 42 is a magnet 44 which is illustrated in FIG. 5.

In an alternate embodiment illustrated in FIG. 4A, wherein like numerals denote like components, the same reference numerals have been employed, however, bearing the suffix “A”. A first bridge portion 30A includes a planar face 34A. A magnetic bolt 38A having, an irregular cross section projects transversely from the planar face 34A and into the socket 42.

It is noteworthy that in accordance with the invention, as the first and second frame members are joined together, they self-align because the irregular bolt cannot be inserted into the socket if they are not registered. Further, inadvertent separation of the lens holding frame members which might result from bending or torsion forces applied at plane of the abutting faces 34, 40 during sporting activities, for example, is precluded because the magnetic contact and coupling plane lies within the second bridge portion spaced from the abutting planar faces 34, 40.

The particular combinations of elements and features in the above-detailed embodiment are exemplary only; the interchanging and substitution of these teachings with other teachings in this application are also expressly contemplated. As those skilled in the art will recognize, variations, modifications, and other implementations of what is described herein can occur to those of ordinary skill in the art without departing from the spirit and the scope of the invention as claimed.

Further, in describing the invention and in illustrating embodiments of the invention in the figures, specific terminology, numbers, materials, etc., are used for the sake of clarity. However the invention is not limited to the specific terms, numbers, materials, etc. so selected, and each specific term, number, material, etc., at least includes all technical and functional equivalents that operate in a similar manner to accomplish similar purpose. Use of a given word, phrase, number, dimension, material, language terminology, product brand, etc. is intended to include all grammatical, literal, scientific, technical, and functional equivalents. The terminology used herein is for the purpose of description and not limitation.

Having described the preferred embodiments of the invention, it will now become apparent to one of ordinary skill in the art that other embodiments incorporating the concept may be used. Moreover, those of ordinary skill in the art will appreciate that the embodiment of the invention described herein can be modified to accommodate and/or comply with changes and improvements in the applicable technology and standards referred to herein.

Thus it will be seen that there is provided eyeglasses with separable frame members which achieves the various aspects, features and considerations of the present invention which is well suited to meet the conditions of practical usage.

1. Eyeglasses comprising a pair of lenses, a frame having a bridge, a pair of temples connected to outer ends of the frame, the frame including a pair of lens holding members, the bridge comprising a pair of separable bridge portions, each bridge portion being connected to a lens holding member, the bridge portions having generally planar faces which engage one another along a common plane when the lens holding members are coupled together, one of the bridge portions including a bolt having a first magnet spaced laterally from the common plane, the other bridge portion including a socket extending from the common plane into the other bridge portion, the socket being registered with the bolt when the lens holding members are coupled together and being configured to compatibly receive the bolt, the socket including a second magnet at its internal end, whereby the first and second magnets will attractively couple the lens holding members together.

2. The eyeglasses constructed in accordance with claim 1 wherein the bolt is irregular in transverse cross section and the socket is irregular in transverse cross section, whereby the lens holding members can mate with one another during assembly and are precluded from rotating relative to one another.

3. The eyeglasses constructed in accordance with claim 1 wherein the bolt comprises the first magnet.

4. The eyeglasses constructed in accordance with claim 1 wherein the first magnet is positioned at the proximal end of the bolt.

5. The eyeglasses constructed in accordance with claim 1 wherein each bridge portion and its associated lens holding member are formed of one piece molded construction.

6. Eyeglass frames comprising a pair of frame segments configured to receive lenses, a bridge selectively joining the lens segments, a pair of temples connected to outer ends of the frame segments, the bridge comprising a pair of separable bridge portions, the bridge portions having generally planar faces which engage one another along a first common plane when the frame segments are coupled together, a first magnet associated with one of the bridge portions, the first magnet being fixed relative to the one bridge portion and being spaced laterally from the common plane, a second magnet associated with the other bridge portion, the second magnet being fixed relative to the other bridge portion and being spaced laterally from the common plane, the first and second magnets having contact faces registered with one another along a second common plane, the first and the second common planes being space laterally from one another, whereby the first and second magnets couple the frame segments together.

7. The eyeglasses constructed in accordance with claim 6 wherein the other bridge portion includes a socket having an internal end, the second magnet being positioned at the internal end of the socket.

8. The eyeglasses constructed in accordance with claim 7 wherein the one bridge portion includes a bolt and the first magnet is positioned at the distal end of the bolt.

9. The eyeglasses constructed in accordance with claim 6 wherein the one bridge portion includes a bolt and the first magnet is positioned at the distal end of the bolt.

10. The eyeglasses constructed in accordance with claim 8 wherein the bolt is irregular in transverse cross section, the socket being configured to compatibly receive the bolt.

11. The eyeglasses constructed in accordance with claim 6 wherein the one bridge portion includes a bolt comprising the first magnet, the bolt being seated in the one bridge portion.

12. An eyeglass frame comprising two lens holding members releasably interconnected at a pair of separable bridge portions, the bridge portions having surfaces which abut one another at a first common plane when the bridge portions are coupled together and the lens holding members are interconnected, a first magnet having a first engagement face associated with one of the bridge portions, a second magnet having a second engagement face associated with the other bridge portion, the first and second engagement faces abutting one another at a second common plane when the bridge portions are coupled together and the lens holding members are interconnected, the first and second common planes being spaced laterally from one another.

13. The eyeglass frame in accordance with claim 12 wherein the other bridge portion includes a socket having an internal end and the second engagement face is positioned at the internal end of the socket.

14. The eyeglass frame in accordance with claim 13 wherein the one bridge portion includes a bolt which projects into the socket.

15. The eyeglass frame in accordance with claim 14 wherein the first magnet is positioned at the distal end of the bolt.

16. The eyeglass frame in accordance with claim 14 wherein the bolt comprises a magnet.

17. The eyeglass frame in accordance with claim 14 wherein the bolt is irregular in transverse cross section and the socket is irregular in transverse cross section, whereby the lens holding members can mate with one another during assembly and are precluded from rotating relative to one another when interconnected.

18. The eyeglass frame in accordance with claim 12 further including a temple connected to each lens holding member.

19. The eyeglass frame in accordance with claim 18 further including a neck band or strap joining the ends of the temples, whereby separated lens holding members will be readily available when needed and not prone to being misplaced when not interconnected.

20. The eyeglass frame in accordance with claim 14 wherein the bolt projects from the surface of the first bridge portion through the first common plane.
